(19) United States
(12) Patent Application Publication
(10) Pub. No.: US 2011/0231189 A1
(43) Pub. Date: Sep. 22, 2011

(54) METHODS AND APPARATUS FOR EXTRACTING ALTERNATE MEDIA TITLES TO FACILITATE SPEECH RECOGNITION

(75) Inventors: Josef Damianus Anastasiadis, Aachen (DE); Christophe Nestor George Couvreur, Sint-Pieters-Kapelle (BE)

(73) Assignee: Nuance Communications, Inc., Burlington, MA (US)

(21) Appl. No.: 12/727,399

(22) Filed: Mar. 19, 2010

(51) Int. Cl. G10L 15/06

(52) U.S. Cl. 704/243; 704/E15.007

(57) ABSTRACT

Techniques for generating a set of one or more alternate titles associated with stored digital media content and updating a speech recognition system to enable the speech recognition system to recognize the set of alternate titles. The system operates on an original media title to extract a set of alternate media titles by applying at least one rule to the original title. The extracted set of alternate media titles are used to update the speech recognition system prior to runtime. In one aspect rules that are applied to original titles are determined by analyzing a corpus of original titles and corresponding possible alternate media titles that a user may use to refer to the original titles.

### BACKGROUND

Digitally stored music has become commonplace as a result of, among other things, peer-to-peer file sharing networks, online music stores, and portable music players. The ease with which digitally stored music can be acquired often results in large datasets of music files from which a user must navigate to select a piece of music content. Some conventional systems identify and address stored music using one or more tags that include information about a particular piece of music such as its genre, song title, album title, and artist name. The user may interact with a user interface to select a desired piece of content from a dataset of music content by searching the dataset using information stored in one or more of the tags. For example, the user may use an input device such as a mouse, a keyboard, or a touchscreen connected to a computer displaying the user interface to select a piece of music for playing by the computer, copying to a storage medium, adding to a playlist, etc.

Some computer systems are equipped with speech recognition capabilities including a speech recognition engine and one or more speech-enabled applications configured to use the speech recognition engine to recognize speech input. Accordingly in some computer systems, speech input provides another technique by which a user may select a piece of music from a dataset of stored music. The speech recognition engine in some such systems may be configured with a limited vocabulary to enable the speech recognition engine to recognize only exact titles for the stored content. This is accomplished by adding the information in the one or more associated tags to the vocabulary of the speech recognizer. At runtime, a user may speak, for example, the name of a song title into a microphone connected to a computer and if the song title in the user utterance exactly matches one of the tags associated with the stored content, the music selection associated with the matching tag may be selected. In other systems, the speech recognition engine may include a large vocabulary that enables the speech recognition engine to recognize any combination of words or substrings in each of the titles of the stored music. The flexibility of the speech recognition engine in recognizing all combinations of words in spoken titles is increased over systems that require exact original titles to be spoken. However, this increased flexibility is at the expense of recognition accuracy and/or resource (e.g., storage) consumption.

### SUMMARY

One embodiment is directed to a method for generating a set of one or more alternate music titles from an original title associated with stored digital music. The method comprises extracting, with at least one processor, the set of alternate music titles by applying at least one rule to the original title; and updating a speech recognition system based, at least in part, on the set of alternate music titles extracted from the original title to enable the speech recognition system to recognize the set of alternate music titles.

Another embodiment is directed to at least one non-transitory computer readable storage medium encoded with a plurality of instructions that, when executed by a computer, perform a method for extracting a set of alternate music titles from a full title associated with stored digital music. The method comprises extracting, with at least one processor, the set of alternate music titles by applying at least one rule to the original title; and updating a speech recognition system based, at least in part, on the set of alternate music titles extracted from the original title to enable the speech recognition system to recognize the set of alternate music titles.

Another embodiment is direct to a computer, comprising: at least one processor programmed to: analyze a corpus of original music titles to determine possible alternate music titles that a user may use to identify the original music titles in the corpus; identify at least one pattern based, at least in part on, relationships between the possible alternate music titles and the original music titles; and create at least one rule for extracting an alternate music title based, at least in part on the at least one pattern.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart of a technique for creating one or more rules for generating alternate music titles in accordance with some embodiments of the invention;

FIG. 2 illustrates an exemplary corpus of titles that may be analyzed to generate a set of alternate titles in accordance with some embodiments of the invention;

FIG. 3 illustrates an exemplary corpus comprising original and alternate titles that may be analyzed in accordance with some embodiments of the invention;

FIG. 4 is a flow chart of a technique for configuring a speech recognition system to recognize alternate music titles in accordance with some embodiments of the invention;

FIG. 5 is a flow chart of a technique for generating a set of alternate titles using category-specific rules in accordance with some embodiments of the invention;

FIG. 6 is a flow chart of a technique for using a speech recognition system configured in accordance with some embodiments of the invention to access stored digital music; and

FIG. 7 is an exemplary computer system that may be used in connection with some embodiments of the invention.

### DETAILED DESCRIPTION

As described above, conventional speech recognition systems configured to recognize and facilitate access of stored digital media (e.g., music) require a user to memorize and speak an entire title which is stored in a tag associated with the stored digital media. For example, a digital copy of the “The Best of 1980-1990” album from the group U2 may be stored on a computer and a user may want to select the song “Pride (In the Name of Love)” for playback by a computer. This song may be associated with the following tags: album: the_best_of_{—}1980-1990, artist: u2, song: pride (in_the_name_of_love). Accordingly, in order to select the song commonly known as “In the name of love,” the user may be required to speak the entire title associated with the song tag (i.e., the user must speak “Pride in the name of love”). In another example, a user may want to select the album “The Beatles” which commonly referred to as “The White Album.” In some embodiments, “The White Album” and/or “White Album” may be used as alternate titles to select music associated with the original album title “The Beatles.” In yet another example, a user may want to select music by the artist “Sean Combs,” commonly known as “Diddy,” “P. Diddy,” “Puff,” “Puffy,” or “Puff Daddy.” Some or all of these alternate names may be used as alternate titles to select music associated with the artist Sean Combs. In existing speech recognition systems if the user fails to remember to speak the entire original title of the song, album, or artist, the title will not be recognized by the speech recognition system and the corresponding music will not be selected by the computer.

Alternatively, as described above, some speech recognition systems are configured to recognize any combination of words or phrases (even in reversed order) of each title of stored media content. Although such systems are more flexible in that they are capable of recognizing a greater number of input utterances, such systems tend to over-generate input possibilities, which has an increasing impact on recognition accuracy with larger stored media datasets. For example, if a stored music dataset includes hundreds or thousands of songs, the number of word combinations that the speech recognition system must be capable of recognizing becomes substantial. Furthermore, the uniqueness of many of the word combinations is also reduced because of a larger number of shared words in titles as the size of the stored media dataset is increased. Accordingly, recognition accuracy suffers.

Applicants have appreciated that existing speech recognition systems that either require a user to memorize and speak an entire original title or allow for any combination of words in a title may be improved upon by allowing the user to select a piece of media content (e.g., music) by speaking an alternate title for the content selection. For example, rather than having to speak the entire official title “Pride (In the Name of Love),” the user may select the song by speaking an alternate title such as “In the Name of Love” or “Pride.” When updated with a likely set of alternate titles for stored media content, the speech recognition system may recognize the alternate title(s) and treat the utterance of an alternate title in a similar manner as if the user spoke the entire original title. Imparting this additional flexibility to a speech recognition system used to access stored media content provides a more user friendly interface that enables a user to access the stored content without having to memorize exact original titles (e.g., it may allow a user to access a song via a “title” that is commonly known, such as “In the Name of Love,” rather than by its actual full title). Additionally, by limiting the recognizable utterances to a set of alternate titles, an improved balance between recognition accuracy and resource consumption may be realized when compared to existing speech recognition systems that allow for any combination of words or phrases to be spoken to access stored media content.

Some embodiments described below relate to processing music titles such as artist names, song titles, and album titles. However, it should be appreciated that embodiments of the present invention may be used with other types of titles for digitally stored media content including, but not limited to, pictures, videos, video games, audio books, other suitable media content, and any combination of one or more of the preceding media types, as aspects of the invention are not limited in this respect.

To enable a speech recognition system to recognize alternate music titles, a set of alternate music titles may be created. Accordingly, some embodiments of the invention are directed to creating a set of one or more alternate music titles by applying one or more rules to a collection of original titles such as a dataset of songs in a library of stored digital music (e.g., an iTunes® library file, see http://apple.com/itunes), a playlist, or another file or list that includes music titles associated with stored digital music. As used herein, the term “title” is used to refer to any one or more of an album title, an artist name (or title), a song title, or any other title associated with stored media content (e.g., an audio-book title, a video title, etc.).

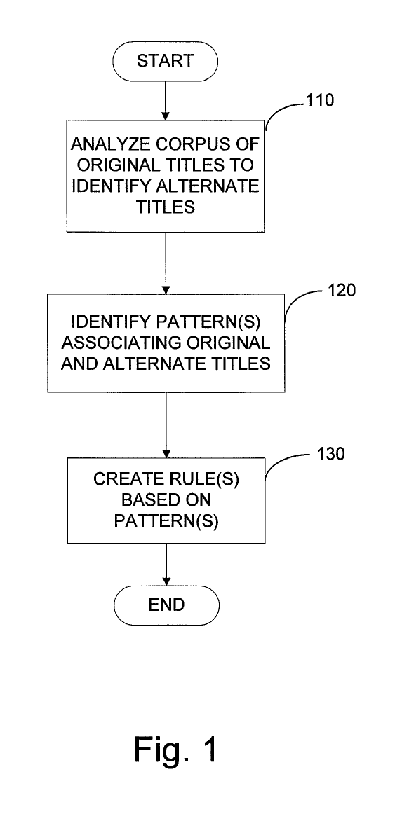

In some embodiments, the rule(s) applied to a collection of original titles may be generated based, at least in part, on an analysis of a large corpus of titles as illustrated in FIG. 1. The corpus on which the rule(s) are based may be created or acquired in any suitable way and embodiments of the invention are not limited in this respect. For example, the corpus may be created from a listing of music in an online music store that includes thousands of music titles. The size of the corpus should be large enough to include a diverse set of titles including multiple examples of different types of titles to facilitate the generation of the rule(s).

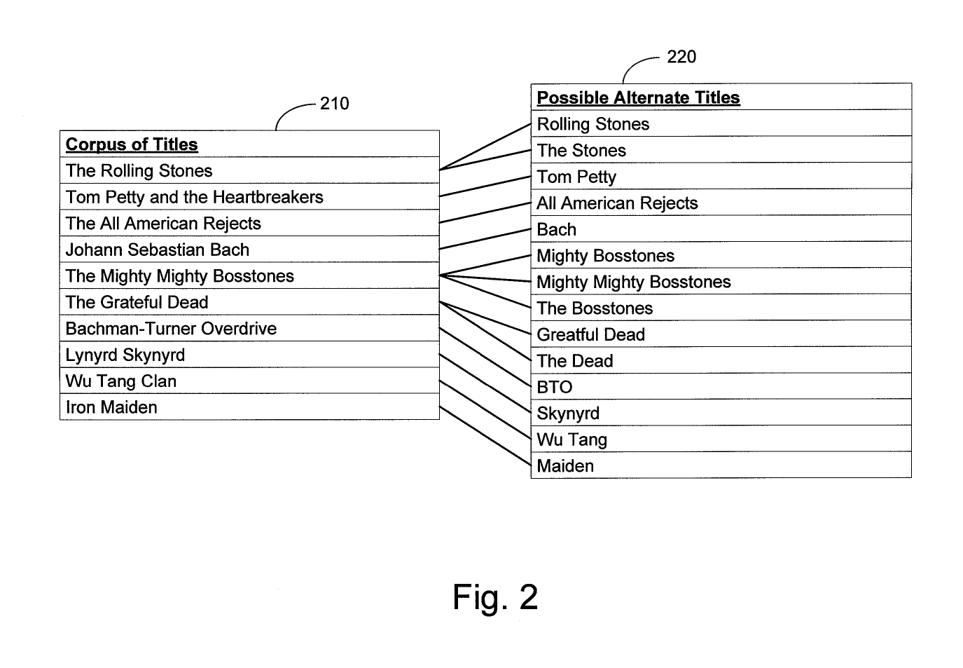

In act 110, a corpus of titles may be analyzed to determine possible alternate titles for the titles in the corpus. An exemplary corpus of titles is illustrated in FIG. 2. In the exemplary corpus 210, only titles of artist names are included, although it should be appreciated that a corpus of titles may also in include other categories of titles including, but not limited to, album titles and song titles. Furthermore, although corpus 210 only includes ten artist titles, corpora for use with some embodiments of the invention include hundreds of titles and other embodiments include thousands of titles. Corpus 210 is shown merely for illustrative purposes.

Based on titles in corpus 210, a plurality of possible alternate titles 220 may be generated that are based on the original titles in corpus 210 and consider how a user is likely to remember or refer to particular titles. An analysis of corpus 210 to determine possible alternate titles 220 that a user is likely to use may be performed in any way and embodiments of the invention are not limited in this respect. For example, in some embodiments, corpus analyses may be informed based on information in articles in trade publications (e.g., online blogs, magazines, etc) and/or any other information source that facilitates a determination of possible alternate titles for the titles included in the corpus. In other embodiments, analyses may include human interaction with the corpus to determine possible alternate titles. These are examples, and any combination of two or more analysis techniques may be used, as the aspects of the invention described herein are not limited in this respect.

In some embodiments, a corpus may include both original titles and alternate titles and generation of possible alternate titles as a separate act may not be necessary. For example, the corpus may be a publicly accessible data set or may be compiled from one or more sources in which individual users provided at least some of the titles. Since users may not always use official titles to refer to music, a corpus based on a public data set or multiple other public sources may include one or more entries where a title is not the official title, but rather is a title that may vary from the official title in some respect. In this respect, some of these variations from the official title may be considered as alternate titles in the corpus.

In some embodiments, alternate titles may correspond to any form of rearrangement of the whole or parts of the original title. For example, alternate titles may be generated from an original title by changing the word order, deleting one or more terms, modifying one or more terms, inserting one or more terms, expanding one or more abbreviations, creating one or more abbreviations, using any other suitable technique, and/or any combination of these techniques.

Different original titles may generate more or fewer alternate titles based on the one or more rules applied to the original titles as described in more detail below. In some instances, many alternate titles may be extracted from a single original title, whereas in other instances, no alternate titles may be extracted from an original title. The ability of a set of rules to extract a particular number of alternate titles is not a limiting factor for embodiments of the invention.

Once possible alternate titles for some or all of the original titles in the corpus are determined, the process proceeds to act 120, wherein associations between the possible alternate titles and the original titles may be analyzed to identify one or more structural patterns for transforming an original title into a possible alternate title. For example, using the example shown in FIG. 2, it can be seen that in four instances, an alternate title for an artist name was created by deleting an initial term “The” (e.g., “The Rolling Stones” becomes “Rolling Stones”). Other patterns, may also be identified such as, for example, deleting terms in brackets (e.g., the original title “Pride (In the Name of Love” becomes the alternate title “Pride”) or using only the last word in the title as an alternate title (e.g., “Iron Maiden” becomes “Maiden”). The one or more structural patterns may be identified in any suitable way and embodiments of the invention are not limited in this respect. In some embodiments, one or more statistical analyses may be used identify the one or more structural patterns. Alternatively, or in addition to statistical analyses, the one or more patterns may be identified by a user manually inspecting and determining the relationships between the original titles and the possible alternate titles.

After identifying the one or more patterns based on associations between possible alternate titles and the original titles, the process proceeds to act 130, wherein one or more rules may be created that describe a transformation from an original music title to an alternate music title as described by the one or more patterns. In some embodiments, a fixed number of rules may be generated based on the identified patterns to limit the number of alternate titles that are generated when the rules are applied to an original title or a collection of original titles associated with a user's stored digital media content in an effort to maintain a balance between flexibility in speech recognition, recognition accuracy, and resource consumption, as described above. For example, a speech recognition device may have limited storage resources and a smaller number of alternative titles may be desired. In such instances, in accordance with some embodiments, only the most commonly occurring rules may be stored by the speech recognition system to preserve the storage resources.

The number of rules generated based on the identified patterns may be limited in any way. For example, in some embodiments, only patterns associated with a high frequency of occurrence in the corpus or in some other collection of public materials may be chosen to be converted into rules. For example, in the corpus analysis illustrated in FIG. 2, the pattern to drop the initial term “the” to create an alternate title occurs four times, the pattern to use the final term of the title as an alternate title occurs three times, and the pattern to create an alternate title by abbreviating the title (e.g., “Bachman-Turner Overdrive” becomes “BTO”) occurs only one time. In accordance with one embodiment in which a threshold value for creating a rule indicates that a pattern must occur multiple times in the corpus, rules based on the first two patterns described above may be created, whereas a rule based on the abbreviation pattern may not be because it is only observed once in the analysis of the corpus. However, in some alternate embodiments, all of the identified patterns, regardless of their frequency of occurrence, may be converted into rules as aspects of the invention are not limited in this respect.

In yet other embodiments, the number of rules that are created may be a fixed number for each category of title. For example, the twenty most frequently occurring structural patterns identified for each category of title may be used to generate rules and these sets of category-specific rules sets may be stored and applied to original titles belonging to that particular category. The number twenty is just an example, as any limit on the number of rules can be used. Also, not all embodiments are limited to placing a limit on the number of rules. The one or more rules may be stored in any suitable manner and may be used to generate one or more sets of alternate titles as described in more detail below.

As described briefly above, in some embodiments, a corpus may comprise both original or “official” titles and also alternate titles. This may occur for any of numerous reasons. For example, if a corpus is a publicly accessible data set or is compiled from one or more sources, the corpus may contain one or more entries where a title is not the official title, but rather is a title that may vary from the official title in some respect. In this respect, it should be appreciated that people are often not aware of the official titles and may refer to a song, artist, or album using an alternate title.

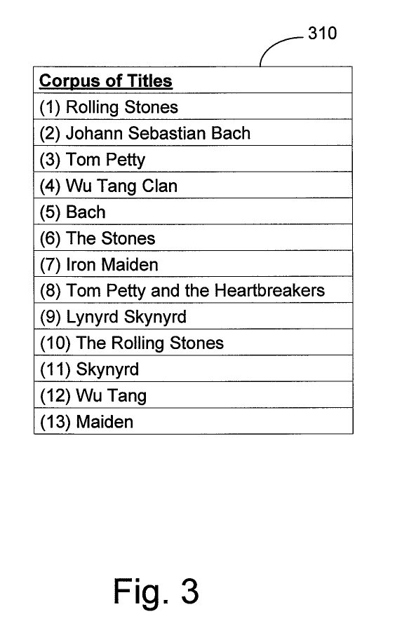

An exemplary corpus 310 including both original and alternate titles is illustrated in FIG. 3. If the corpus 310 is sufficiently large and includes information from a number of sources, it may be considered to reflect the types of alternate title people use to access the corresponding music. Thus, rather than generating possible alternate titles based on original titles in a corpus, in some embodiments, a corpus including original titles and alternate titles may be analyzed (e.g., via at least one programmed processor) to identify occurrences of similar titles and extract the relationships between the similar titles to determine one or more structural patterns, examples of which were discussed above. Based on the identified patterns, one or more rules may be created in the same manner as described above. Much like the embodiments described above wherein rules are defined by comparing the corpus to a set of alternate titles, in some embodiments, limits may be placed on the number o rules adopted, but the aspects of the invention described herein are not limited in this respect.

An analysis of corpus 310 may group similar music titles that refer to the same artist (or song or album) and the groups may be analyzed to identify one or more patterns that associate an original title to an alternate title. Grouping of titles in a corpus may be performed in any suitable way. For example, in some embodiments, entries in the corpus that include at least some of the same words and/or phrases may be grouped although other criteria may also be used for grouping entries in a corpus and aspects of the invention are not limited in this respect.

An exemplary analysis of corpus 310 in accordance with some embodiments may group the following titles with each group corresponding to the same artist: titles (1), (6), and (10); titles (2) and (5); titles (3) and (8); titles (4) and (12); titles (7) and (13); and titles (9) and (11). These groupings may be analyzed to determine relationships between an original title and alternate titles in a group and at least the following patterns may be identified: (1) delete the initial term ‘the’ in title; (2) include only last term in title, (3) when title starts with ‘the’ include ‘the’ and last term in title, (4) delete last term in title, and (5) divide title when the term ‘and’ is in title. These patterns may be used to generate one or more rules as described above. While corpus 310 only includes thirteen titles and only includes artist name titles, it should be appreciated that other categories of music titles may alternatively be analyzed and a corpus including many more (e.g., hundreds or thousands) of titles may be used to facilitate an identification of patterns in the corpus in some embodiments.

In some embodiments, different rules may be created for different categories of titles in the corpus. The corpus may include titles that are artist names, album titles, and song titles, and the rules that are created for each category may be the same or different. For example, artists frequently collaborate on songs with one or more other “featured” artists. For such songs, the original title represented in the artist name tag often includes one or more of the terms “featuring, “f.” or “feat.” followed by the name of the featured artist(s) (e.g., Beyonce feat. Jay-Z). Accordingly, one exemplary rule that may be specific to artist name titles as opposed to album titles or song titles, may be to create one or more alternate titles when the term ‘featuring,’ ‘f.,’ or ‘feat.’ is found in the title. Additionally, in some embodiments, different categories of titles may be associated with the same rules, but the rules may be applied in a different order to an original title to generate alternate title(s). Other exemplary rules in accordance with some embodiments of the invention are described in more detail below.

As discussed above, in some embodiments a corpus that includes both original titles and alternate titles may be analyzed to generate rules that may be used to generate alternate titles when applied to a collection of original titles. In such embodiments in which alternate titles are included in the corpus, rules may be generated based on groupings of similar titles as described above, rather than being generated from a corpus that includes only original titles.

A set of exemplary rules for artist name titles in accordance with some embodiments is illustrated in Table 1.

TABLE 1
Exemplary Rules for Artist Names

| Rule | Example |
|---|---|
| Expressions within brackets (e.g., { }, | “Future (feat. kid Cudi)” |
| ( ), [ ]) are optional | becomes “Future” |
| ‘The’ at beginning of name is optional | “The Beatles” becomes |
| | “Beatles” |
| Replace all occurrences of ‘&’ by ‘and’ | “Me & U” becomes “Me and U” |
| Divide original title into parts around | “Lil Jon & Three 6 Mafia” |
| delimiters ‘&’ ‘and’ ‘with’ | becomes both “Lil Jon” and |
| ‘featuring’ and make parts optional | “Three 6 Mafia” |
| Replace substrings in the form ‘7″’ and | “The 12″ collection” becomes |
| ‘12″’ with the form ‘7-inch’ and | “The 12 inch collection” |
| ’12-inch’ | |
| Move ‘the’ at end of name to | “Beatles, The” becomes “The |
| the beginning | Beatles” |
| Expand occurrences of ‘f.,’ ‘feat.,’ | “Baby feat. Ludacris” becomes |
| ‘feat,’ and similar to ‘featuring’ | “Baby featuring Ludacris” |

A set of exemplary rules for song titles in accordance with some embodiments is illustrated in Table 2.

TABLE 2
Exemplary Rules for Song Titles

| Rule | Example |
|---|---|
| Expressions within brackets (e.g., | “(You gotta) fight for your right (to |
| { }, ( ), [ ]) are optional | party)” becomes the three alternate |
| | titles “fight for your right,” |
| | “fight for your right to party,” |
| | and “you gotta fight for your |
| | right” |
| Replace all occurrences of ‘&’ by | “Me & U” becomes “Me and |
| ‘and’ | U” |
| Divide original title into parts around | “Brain Damage/Eclipse” |
| delimiters ‘-’ ‘?’ ‘/’ ‘\’ | becomes both “Brain Damage” |
| ‘.’ ‘:’ and make parts optional | and “Eclipse” |
| Replace substrings in the form ‘7″’ | “Slow down 12″ version” becomes |
| and ‘12″’ with the form ‘7-inch’ | “Slow down 12 inch version” |
| and ’12-inch’ | |
| Expand occurrences of ‘f.,’ ‘feat.,’ | “Kiss Kiss feat. T-Pain” becomes |
| ‘feat,’ and similar to ‘featuring’ | “Kiss Kiss featuring T-Pain” |
| Replace ‘#’ followed by a number | “Rainy day woman #12” becomes |
| with ‘number’ | “Rainy day woman number 12” |

A set of exemplary rules for album titles in accordance with some embodiments is illustrated in Table 3.

TABLE 3
Exemplary Rules for Album Titles

| Rule | Example |
|---|---|
| Expressions within brackets (e.g., | “The Ecleftic (2 Sides II A Book)” |
| { }, ( ), [ ]) are optional | becomes both “The Ecleftic” and |
| | “2 Sides II A Book” |
| Replace all occurrences of ‘&’ by | “Beats, Rhymes, & Life” becomes |
| ‘and’ | “Beats, Rhymes, and Life” |
| Divide original title into parts around | “Peg Luksik Speaks: Two Sets of |
| delimiters ‘-’ ‘?’ ‘/’ ‘\’ ‘.’ | Standards” becomes both “Peg |
| ‘:’ and make parts optional | Luksik Speaks” and “Two Sets of |
| | Standards” |
| Replace substrings in the form ‘7″’ | “Slow down 12″ version” becomes |
| and ‘12″’ with the form | “Slow down 12 inch version” |
| ‘7-inch’ and ’12-inch’ | |
| Expand occurrences of ‘f., ’ | “Kiss Kiss feat. T-Pain” becomes |
| ‘feat., ’ ‘feat, ’ and | “Kiss Kiss featuring T-Pain” |
| similar to ‘featuring’ | |
| Replace ‘#’ followed by a number | “Rainy day woman #12” becomes |
| with ‘number’ | “Rainy day woman number 12” |
| Make ‘The’ at beginning of | “The best of the emotions” |
| album optional | becomes “Best of the emotions” |
| Expand all occurrences of ‘vol.’ | “Greatest hits, Vol. 2” becomes |
| ‘vol’ and similar to ‘volume’ | “Greatest hits, volume 2” |
| Make occurrence of expressions like | “Greatest hits volume 2” becomes |
| ‘CD XX’ ‘Volume XX’ where | “Greatest hits” |
| XX is a number optional | |
| Make first occurrence of ‘and’ | “Big Whiskey and the GrooGrux |
| ‘featuring’ ‘with’ | King” becomes “Big Whiskey |
| and similar optional | the GrooGrux King” |

Although the foregoing tables provide lists of exemplary rules for generating a set of one or more alternate titles from original titles, it should be appreciated that other suitable rules may be used instead of or in addition to any combination of the frequency rules as aspects of the invention disclosed herein are not limited in this respect. In some embodiments, the rules that are created may be dependent on a particular language and/or culture with which a speech recognition system is intended to be used. Furthermore, in some embodiments, the rules that are created, when applied to a particular group of titles, may not result in all possible alternate titles that a user may speak for all of the original titles in the particular group. Rather, as described above, in some embodiments, the number of rules may be limited to reduce the number of alternate titles created when applying the rules to one or more original titles. For example, in some embodiments, the rules may be created based on a frequency of observance of patterns in a corpus and the rules may be designed to encompass the majority of possible alternate titles that a user may use to refer to stored digital music having an associated original title.

After a set of one or more rules has been generated, in some embodiments the rule(s) may be subjected to a verification process to test whether or not the rules sufficiently capture the ways in which users commonly refer to music titles. In such a verification process, the rules may be used to parse original titles associated with a user's stored digital music and the user may be instructed to spontaneously speak desired music titles for reproduction. The verification process may determine the ability of a speech recognition system to correctly identify the spoken titles, and feedback provided by the verification process may be used to improve the rules and/or verify a priority for applying the rules to titles prior to runtime of the speech recognition system. It should be appreciated, however, that not all rules may be verified using the aforementioned verification process and embodiments of the invention are not limited to any particular type of verification process or to performing verification at all.

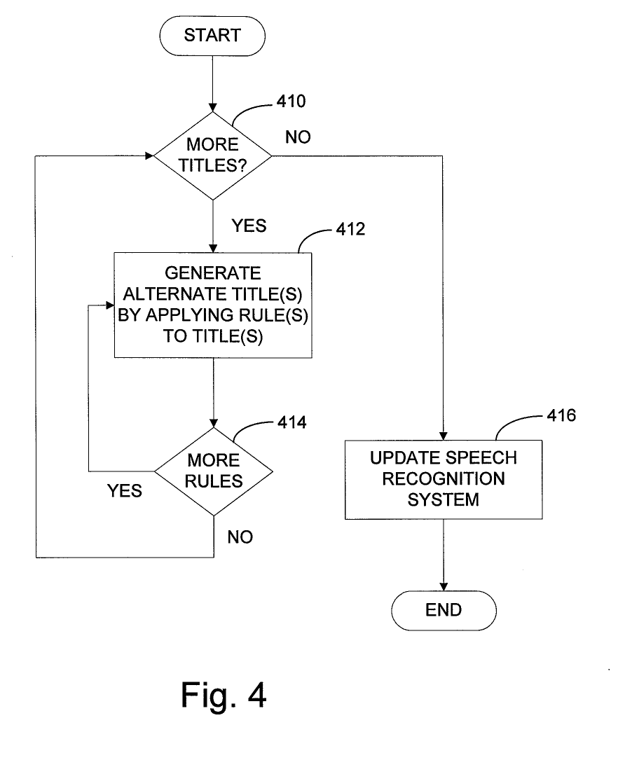

Once a set of rules has been established, some or all of the rules may be applied to a collection of one or more original titles associated with stored digital media content (e.g., a library of songs managed by iTunes® available from Apple, Inc.) to generate a set of one or more alternate titles for the collection. An illustrative non-limiting process for generating alternate titles based on a set of rules is illustrated in FIG. 4. In act 410, it is determined whether all of the titles in the collection have been processed. If it is determined that additional titles remain to be processed, the process proceeds to act 412, wherein a set of alternate titles for the original title is generated based on the application of a rule. It should be appreciated that all rules may not be applicable to all titles in some embodiments (e.g., all artist names may not begin with the term “the”) and accordingly, the number of members in the set of alternate titles generated in act 412 may vary considerably depending on an application of a particular rule to a particular title or group of titles. The set of alternate titles generated in act 412 may be stored in any suitable manner for further processing.

In some embodiments in which multiple rules are applied to titles in a collection, the plurality of rules may be applied in any suitable manner. In one embodiments, the multiple rules may be applied in a cascaded manner so that the result set of alternate titles is representative of applying the rules sequentially to the output set of the previous rule. For example, application of a first rule to input title t₀ may result in a set of alternate titles {t₁, t₂, . . . t_{N}}, where N is the number of alternate titles generated for the title t₀. A second rule may be applied to the original title (t₀) and the set of alternate titles {t₁, t₂, . . . t_{N}} output from the first rule resulting in an expanded set of alternate titles that includes those generated from application of the first rule and the second rule (e.g., {t₁, t₂, . . . t_{N} U t₁₁, t₁₂, . . . , t_{1M}, t₂₁, t₂₂, . . . , t_{2M}, . . . , t_{N1}, t_{N2}, . . . , t_{NM}}, where M is the number of titles generated for each alternate title in the output set {t₁, t₂, . . . , t_{N}} generated by application of the first rule. Although the number of titles M is shown to be equal for each of the alternate titles {t₁, t₂, . . . t_{N}}, it should be appreciated that different numbers of alternate titles may be generate based on the application of a particular rule to a particular title. A third rule may be applied to the original title and this expanded set of alternate titles, and so on until all of the rules have been applied. Accordingly, in act 414 it is determined whether all of the rules have been applied. If it is determined that more rules should be applied, the process returns to act 412 where a new rule is applied to the set of alternate titles. The process continues until it is determined in act 414 that no more rules are to be applied to the title or group of titles, at which point the process returns to act 410 to determine whether there are more titles to be processed.

Aspects of the present invention described herein are not limited to applying a plurality of rules in a cascaded manner as described above. In other embodiments, the one or more rules may be applied to titles or groups of titles using any other suitable technique. For example, each rule may be applied one-by-one to original titles in the collection to reduce the number of members in the set of alternate titles that are generated or a combination of cascaded and one-by-one rule application may alternatively be used.

The order in which rules are applied to titles may be predetermined based on any suitable criteria or randomly determined, as aspects of the invention are not limited in this respect. For example, in some embodiments, the order in which the rules are applied may be specified based on a frequency with which a corresponding structural pattern was detected in an analysis of a corpus as described above. That is, the rules generated based on the patterns found most frequently may be applied first and the remaining rules may be applied in descending order of frequency of occurrence of the corresponding patterns in the corpus. As described above, the order of application of the rules may also be different depending on a category of titles to which the rules are being applied. For example, similar rules may be applied to album titles and song titles, but their order of application for album titles versus song titles may depend on one or more criteria (e.g., frequency of observance in corpus).

After it is determined in act 414 that all of the rules have been applied, the process returns to act 410 where it is determined if there are additional unprocessed titles in the collection of titles. If it is determined that there are additional titles, acts 412 and 414 of the process are repeated until all of the titles in the collection of titles have been processed.

If it is determined in act 410 that all of the titles have been processed, the process proceeds to act 416, wherein the set of generated alternate music titles are used to update a speech recognition system to enable the speech recognition system to recognize the set of alternate music titles. The speech recognition system may be updated in any suitable way. For example, a vocabulary of utterances that the speech recognition system is capable of recognizing may be expanded by including the set of alternate music titles in the vocabulary. This may be accomplished in any suitable way. For example, each of the alternate title text strings may be converted into an acoustic and/or phonemic representation that the speech recognition system is capable of recognizing, and the mapping between the text string representing the alternate title and the acoustic and/or phonetic representation may be stored in the updated vocabulary of the speech recognition system.

Updating the speech recognition system may also include associating each of the members in the set of alternate music titles with the corresponding digital music accessible by a user's computer to facilitate the selection of a piece of stored digital music in response to a recognized utterance. That is, in addition to updating the speech recognition system to recognize alternate music titles, the recognized alternate title may be associated with a corresponding piece of music to enable a selection of the corresponding piece of music. The association between an alternate music title and a piece of stored digital music may be formed in any suitable way. For example, in some embodiments, one or more additional tags indicating the alternate titles may be associated with the stored digital music, and each of the one or more additional tags may be output by the speech recognition system for a corresponding recognized utterance to identify the corresponding piece of music. However, although using additional tags that can be identified directly by an output of the speech recognition system is one technique for associating alternate titles with stored digital music, other techniques are also possible. For example, in some embodiments, the speech recognition system may provide speech recognition results to an intermediary application or process which maps the alternate title to the corresponding original title. The mapped original title may then be provided to an application executing on a user's computer to enable the application to select the corresponding piece of music using the original title. In other embodiments, some applications (e.g., digital media management applications) may be capable of accepting partial title information to select a piece of media content (e.g., a song) and mapping between a recognized alternate title and an original title may not be necessary. In such embodiments, the updated speech recognition system upon recognizing an utterance, may provide the alternate title to the application to enable the application to select the corresponding piece of media content.

Updating the speech recognition system may include operations other than updating a vocabulary and embodiments of the invention are not limited in this respect. For example, updating the speech recognition system may include generating at least one grammar based, at least in part, on the set of alternate music titles.

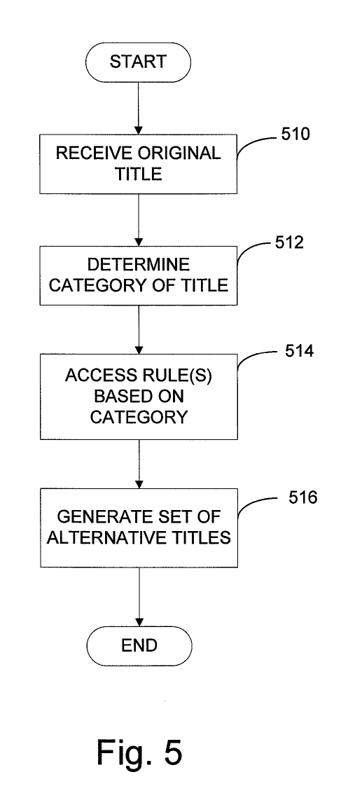

As described above, in some embodiments, rules may be applied to a collection of titles based on the category of the titles in the collection. An illustrative non-limiting technique for applying category-specific rules to an original title in accordance with some embodiments of the invention is illustrated in FIG. 5. In act 510 an original title is received and in act 512, the category of the title is determined. For example, the category of the title may be determined to be an album title, an artist title, or a song title. The category of the title may be determined in any suitable way.

In one non-limiting example, information in one or more category-specific rules may be used to determine the category. For example, an exemplary rule that may be used to generate alternate titles from album titles is to expand all occurrences of ‘vol.’ ‘vol’ and similar to ‘volume.’ Accordingly, if the title includes an occurrence of ‘vol.’ ‘vol’ or ‘volume,’ it may be determined that the title is an album title. In some embodiments, the category may be determined with an associated level of confidence and a confidence score representing the associated level of confidence may compared to a threshold value to determine whether to proceed with generating a set of alternate titles using a category-specific rule set. For example, if the confidence score is low, a user may be prompted (e.g., by a user interface associated with the speech recognition system) to provide the category of the title. Some embodiments may include a user interface that instructs the user to input “song,” “album,” “artist,” or any suitable word or phrase that identifies the category of the title. The input may be provided in any suitable manner including, but not limited to, speech input, text input, and mouse selection input. In some embodiments, after a user specifies a category for the title (e.g., album), an application executing on a user's computer to manage stored music may return identifiers for all pieces of music related to the specified category (e.g., all albums sorted by artist). In another embodiment, if the category is not known, one or more category independent rules (e.g., shared rules among categories) may be applied to the title to generate one or more alternate titles.

In act 514, rules are accessed based, at least in part, on the category of the received title if the category can be determined. In act 516 the category-specific rules are applied to the title to generate a set of alternate music titles as described above. Although the technique illustrated in FIG. 5 refers to processing a single title, it should be appreciated that the technique also may be applied to a collection of received titles, as aspects of the invention are not limited in this respect. Furthermore, when the one or more rules are applied to a collection of titles to generate alternate titles prior to runtime of the speech recognition system, a determination of the category of the titles in the collection of titles may be facilitated by estimating a category likelihood based, at least in part, on some or all of the titles in the collection.

A speech recognition system may be updated using one or more of the techniques described above prior to accepting speech input during execution of a speech recognition application. During such “preprocessing,” the speech recognition engine may be prepared to recognize the alternate titles for any corresponding original titles associated with a locally and/or remotely stored digital music collection. In some embodiments, when the speech recognition system is updated with alternate music titles for a first time, each of the original titles may be processed using one or more of the above-described techniques. Subsequently, when the speech recognition system is updated, only titles corresponding to digital music stored since the last update may be processed to determine additional alternate music titles for the recently stored digital music. It should be appreciated, however, that in some embodiments, each time the speech recognition system is updated, all of the titles associated with stored digital music may be processed, as embodiments of the invention are not limited in this respect.

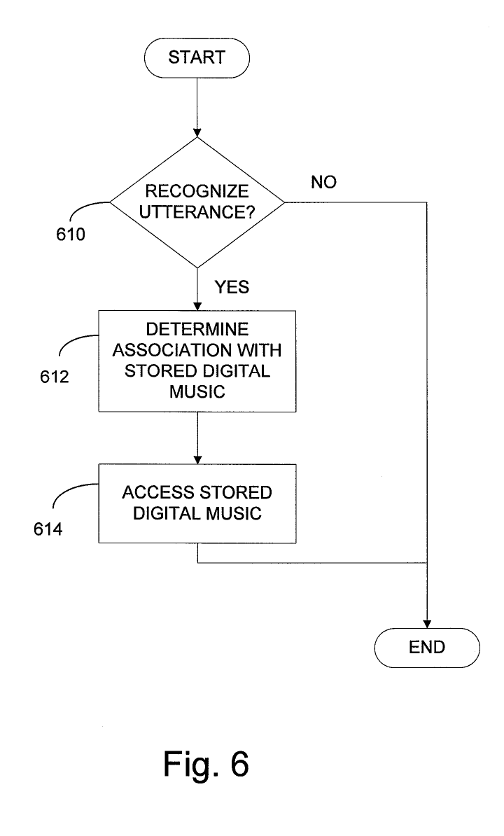

After the speech recognition system has been updated, the updated speech recognition system may be used to access locally and/or remotely stored digital music as illustrated in FIG. 6. In act 610 it is determined whether a received utterance is recognized by the speech recognition system (e.g., whether the utterance is within the recognition vocabulary of the speech recognition system). If it is determined that the utterance is not recognized, the process ends. In some embodiments, an indication (e.g., a visual, audible, and/or other indication) is provided to the user indicating that the requested title was not recognized.

When the utterance is recognized by the speech recognition system, the process proceeds to act 612, wherein an association between the recognized utterance and the corresponding music is determined. As described above, the association between an alternate title and a corresponding piece of music may be determined in one of numerous ways and aspects of the invention are not limited in this respect. For example, in some embodiments, when the speech recognition system is updated, the speech recognition system may output one or more additional tags that inform a music application executing on a user's computer that each of the generated alternate titles for a particular original music title may be associated with the original music title. In other embodiments, the speech recognition system may provide speech recognition results to an intermediary application or process which maps the alternate title to the corresponding original title. The mapped original title may then be provided to a music management application or the like to select the corresponding piece of music. In other embodiments, some applications may be capable of accepting partial title information to select a piece of music and mapping between a recognized alternate title and an original title may not be necessary. In such embodiments, the updated speech recognition system upon recognizing an utterance may provide the alternate title to the application to enable the application to select the corresponding piece of music.

In act 614, the corresponding piece of music associated with the recognized utterance (e.g., original title or alternate title) is accessed based, at least in part, on the association between the recognized utterance and the corresponding piece of music.

As described above, although some embodiments of the invention have been described primarily with reference to processing music titles, it should be appreciated that titles for stored media content other than music titles including, but not limited to pictures, videos, audio books, and video games, other suitable media, or any combination of the preceding, may alternatively be used as aspects of the invention are not limited in this respect.

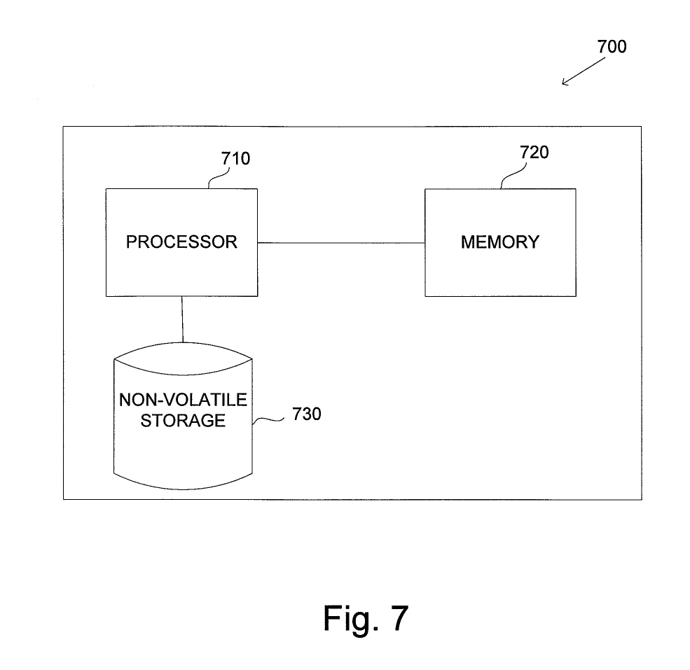

A speech recognition system for recognizing alternate media titles received via a speech recognition application in accordance with the techniques described herein may take any suitable form, as aspects of the present invention are not limited in this respect. An illustrative implementation of a computer system 700 that may be used in connection with some embodiments of the invention is shown in FIG. 7. The computer system 700 may include one or more processors 710 and computer-readable non-transitory storage media (e.g., memory 720 and one or more non-volatile storage media 730, which may be formed of any suitable non-volatile data storage media). The processor 710 may control writing data to and reading data from the memory 720 and the non-volatile storage device 730 in any suitable manner, as the aspects of the present invention described herein are not limited in this respect. To perform any of the functionality described herein, the processor 710 may execute one or more instructions stored in one or more computer-readable storage media (e.g., the memory 720), which may serve as non-transitory computer-readable storage media storing instructions for execution by the processor 710.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one non-transitory computer-readable storage medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method for generating a set of one or more alternate music titles from an original title associated with stored digital music, the method comprising:
extracting, with at least one processor, the set of alternate music titles by applying at least one rule to the original title; and
updating a speech recognition system based, at least in part, on the set of alternate music titles extracted from the original title to enable the speech recognition system to recognize the set of alternate music titles.

2. The method of claim 1, wherein updating the speech recognition system comprises associating each member of the set of alternate music titles with the stored digital music.

3. The method of claim 2, further comprising:
recognizing, by the speech recognition system, an utterance from a user; and
accessing the stored digital music when it is determined that the recognized utterance corresponds to a member of the set of alternate music titles.

4. The method of claim 1, wherein the original title is selected from a group consisting of an album title, a song title, and an artist title.

5. The method of claim 1, wherein the at least one rule comprises rearranging at least one word in the original title.

6. The method of claim 1, wherein the at least one rule comprises a plurality of rules and the method further comprises applying the plurality of rules to the original title in a cascaded manner to generate the set of alternate music titles.

7. The method of claim 1, wherein the at least one rule comprises expanding at least one abbreviation in the original title to at least one word associated with the at least one abbreviation.

8. The method of claim 1, wherein the at least one rule comprises replacing at least one symbol in the original title with at least one word corresponding to the at least one symbol.

9. The method of claim 1, wherein the at least one rule comprises deleting an expression within brackets in the original title.

10. The method of claim 1, wherein the at least one rule comprises dividing based, at least in part, on at least one delimiter in the original title, the original title into two or more components that each comprises a member of the set of alternate music titles.

11. The method of claim 1, wherein the at least one rule comprises deleting at least one word from the original title.

12. The method of claim 1, wherein updating the speech recognition system comprises:
generating at least one grammar for the speech recognition system based, at least in part on the set of alternate music titles.

13. The method of claim 1, further comprising:
selecting the at least one rule based, at least in part, on a category of the original title, wherein the category is selected from a group consisting of an album title, a song title, and an artist title.

14. At least one non-transitory computer readable storage medium encoded with a plurality of instructions that, when executed by a computer, perform a method for extracting a set of alternate music titles from a full title associated with stored digital music, the method comprising:
extracting, with at least one processor, the set of alternate music titles by applying at least one rule to the original title; and
updating a speech recognition system based, at least in part, on the set of alternate music titles extracted from the original title to enable the speech recognition system to recognize the set of alternate music titles.

15. The computer readable storage medium of claim 14, wherein the method further comprises:
selecting the at least one rule based, at least in part, on a category of the original title, wherein the category is selected from a group consisting of an album title, a song title, and an artist title.

16. The computer readable storage medium of claim 14, wherein the at least one rule comprises a plurality of rules and the method further comprises applying the plurality of rules to the original title in a cascaded manner to generate the set of alternate music titles.

17. The computer readable storage medium of claim 14, wherein updating the speech recognition system comprises:
generating at least one grammar for the speech recognition system based, at least in part on the set of alternate music titles.

18. A computer, comprising:
at least one processor programmed to:
analyze a corpus of original music titles to determine possible alternate music titles that a user may use to identify the original music titles in the corpus;
identify at least one pattern based, at least in part on, relationships between the possible alternate music titles and the original music titles; and
create at least one rule for extracting an alternate music title based, at least in part on the at least one pattern.

19. The computer of claim 18, wherein the at least one processor is further programmed to:
identify the at least one pattern by applying at least one statistical analysis to the possible alternate music titles.

20. The computer of claim 18, wherein the at least one processor is further programmed to:
determine a frequency of occurrence of the at least one pattern in the corpus; and
create the at least one rule only when the frequency of occurrence of the at least one pattern is greater than a threshold value.

21. A method for generating a set of one or more alternate media titles from an original title associated with stored digital media content, the method comprising:
extracting, with at least one processor, the set of alternate media titles by applying at least one rule to the original title; and
updating a speech recognition system based, at least in part, on the set of alternate media titles extracted from the original title to enable the speech recognition system to recognize the set of alternate media titles.

22. The method of claim 21, wherein the stored digital media content is selected from a group consisting of music, pictures, videos, audio books, and video games.
